(19) United States
(12) Patent Application Publication
(10) Pub. No.: US 2011/0311417 A1
(43) Pub. Date: Dec. 22, 2011

(54) Apparatus for Biopolymer Synthesis

(75) Inventors: Mo-Huang Li, Singapore (SG); Jackie Y. Ying, Singapore (SG); Yoke Kong Kuan, Singapore (SG); Wai Chye Cheong, Singapore (SG)

(73) Assignee: AGENCY FOR SCIENCE, TECHNOLOGY AND RESEARCH, Singapore (SG)

(21) Appl. No.: 13/127,976

(22) PCT Filed: Nov. 6, 2008
(86) PCT No.: PCT/SG2008/000426

§ 371 Date: Aug. 31, 2011

(51) Int. Cl. B01L 3/00

(52) U.S. Cl. 422/552

(57) ABSTRACT

The present invention relates to an apparatus for biopolymer synthesis wherein said apparatus comprises at least one support having a plurality of microwells and wherein said microwells comprise a porous substrate providing a surface area for biopolymer synthesis.

### TECHNICAL FIELD

The present invention relates to apparatus for biopolymer synthesis and use thereof. In particular the present invention relates to apparatus with flow through porous substrates for biopolymer synthesis and use thereof.

### BACKGROUND

The use of substrates in microarray analysis and synthesis are known. For Instance, methods to create a thin layer of silica particles on a planar glass support surface for two-dimensional DNA micro array synthesis exist. The porous layer of silica particles are overlaid on a support structure, typically glass, which serves as a mechanical support for ease of handling of a porous region. One problem associated with this and similar designs is that the flat porous surface allows diffusion of biopolymer units through the particles before they form part of the biopolymer that is being synthesised on the layer. This has the effect of producing a diffuse area of biopolymer and limits the number of discreet spots or areas available for biopolymer synthesis. Similarly, in a DNA microarray application of such a design, the diffusion of molecules through the particles introduces a rate-limiting step in a hybridisation reaction and the diffuse area of biopolymer limits the signal produced and thus the sensitivity of the array.

Flow-through apparatus having sample wells formed in a glass support are also known. In some apparatus the bottom of each sample contains a porous silicon wafer which acts as a substrate for biopolymer attachment. Such devices have a small surface area which is capable of being functionalized with biopolymer thus limiting the density of biopolymer per unit area. In applications such as DNA microarrays this limits the sensitivity of detection.

An additional problem with existing apparatus for biopolymer synthesis is the evaporation of reagents before completion of the synthesis reaction. This is particularly prevalent in micro scale biopolymer synthesis where nanoliter volumes of reagents may evaporate before completion of the synthesis reaction therefore leading to inefficient biopolymer synthesis and decreasing the purity of the synthesised biopolymer.

Thus there remains a need for an apparatus with a porous flow through substrate for biopolymer synthesis which provides discreet areas with a high surface area for biopolymer synthesis.

### SUMMARY

According to a first aspect of the present invention there is provided an apparatus for biopolymer synthesis wherein said apparatus comprises

at least one support having a plurality of microwells and wherein

said microwells comprise a porous substrate providing a surface area for biopolymer synthesis.

According to a second aspect of the present invention there is provided an apparatus for biopolymer synthesis wherein said apparatus comprises

at least one support having a plurality of microwells and wherein

said microwells comprise a porous substrate providing a surface area for biopolymer synthesis and wherein

said microwells include a sieve member to retain said porous substrate.

According to a third aspect of the present invention there may be provided an apparatus for biopolymer synthesis wherein said apparatus comprises
at least one support having a plurality of microwells and wherein
said microwells comprise a porous substrate providing a surface area for biopolymer synthesis and wherein
said microwells include at least one region adapted to retain said porous substrate.

In one embodiment the support may be a chip of glass or silicon. Alternatively, the support may be a microwell plate.

In an alternative embodiment the porous substrate provides a high surface area for biopolymer synthesis. The surface area of the porous substrate may be from about 10 m²/g to about 200 m²/g or from 20 m²/g to about 180 m²/g or from 30 m²/g to about 160 m²/g or from 30 m²/g to about 140 m²/g or from 40 m²/g to about 120 m²/g or from 50 m²/g to about 110 m²/g or from 60 m²/g to about 100 m²/g.

In one embodiment the biopolymer may be selected from the group comprising DNA, RNA, peptides, polypeptides, polysaccharides, polyhydroxyalkanoates, polyphenols, polysulfates or any combination thereof.

In one embodiment the biopolymer may be an oligonucleotide.

In an alternative embodiment the porous substrate may be selected from the group consisting of porous glass beads, silica particles, monolithic silica or a combination thereof. The monolithic silica or silica particles may be formed in the microwells.

In one embodiment the monolithic silica or silica particles may be sol-gel derived.

In a further embodiment the porous substrate may be functionalised with N-(3-triethoxysilylpropyl)-4-(hydroxybutyramide) then treated with 9-o-dimethoxytrityl-triethylene glycol, 1-[(2-cyanoethyl)-(N,N-diisopropyl)]-phosphoramidite for oligonucleotide synthesis.

In a still further embodiment the porous substrate may be functionalised with a cleavable linker to allow selective elution of the synthesised biopolymer, for example an oligonucleotide.

The cleavable linker may be selected from the group comprising [3-(4,4′-Dimethoxytrityloxy)-2,2-dicarboxyethyl]propyl-(2-cyanoethyl)-(N,N-diisopropyl)-phosphoramidite; 2-[2-(4,4′-Dimethoxytrityloxy)ethylsulfonyl]ethyl-(2-cyanoethyl)-(N,N-diisopropyl)-phosphoramidite; [3-(4,4′-Dimethoxytrityloxy)-2,2-dicarboxymethylamido]propyl-(2-cyanoethyl)-(N,N-diisopropyl)-phosphoramidite (Solid CRP II, Glen Research) or any combination thereof.

According to a fourth aspect of the present invention there is provided an apparatus for biopolymer synthesis wherein said apparatus comprises
at least one support having a plurality of microchannels and wherein
said microchannels comprise a porous substrate providing a surface area for biopolymer synthesis.

In an alternative embodiment the porous substrate provides a high surface area for biopolymer synthesis. The surface area of the porous substrate may be from about 10 m²/g to about 200 m²/g or from 20 m²/g to about 180 m²/g or from 30 m²/g to about 160 m²/g or from 30 m²/g to about 140 m²/g or from 40 m²/g to about 120 m²/g or from 50 m²/g to about 110 m²/g or from 60 m²/g to about 100 m²/g.

In one embodiment the support may be a chip of glass or silicon. Alternatively, the support may be a microchannel plate.

In an alternative embodiment the porous substrate may be selected from the group consisting of porous glass beads, silica particles, monolithic silica or a combination thereof. For example, the monolithic silica or silica particles may be formed in the microchannel.

In one embodiment the monolithic silica or silica particles may be sol-gel derived.

In a further embodiment the porous substrate may be functionalised with N-(3-triethoxysilylpropyl)-4-(hydroxybutyramide) then treated with 9-o-dimethoxytrityl-triethylene glycol, 1-[(2-cyanoethyl)-(N,N-diisopropyl)]-phosphoramidite for oligonucleotide synthesis.

In one embodiment the porous substrate may be functionalised with a cleavable linker to allow selective elution of the synthesised biopolymer, for example an oligonucleotide.

The cleavable linker may be selected from the group comprising [3-(4,4′-Dimethoxytrityloxy)-2,2-dicarboxyethyl]propyl-(2-cyanoethyl)-(N,N-diisopropyl)-phosphoramidite; 2-[2-(4,4′-Dimethoxytrityloxy)ethylsulfonyl]ethyl-(2-cyanoethyl)-(N,N-diisopropyl)-phosphoramidite; [3-(4,4′-Dimethoxytrityloxy)-2,2-dicarboxymethylamido]propyl-(2-cyanoethyl)-(N,N-diisopropyl)-phosphoramidite (Solid CRP II, Glen Research) or any combination thereof.

According to a fifth aspect of the present invention there is provided a use of an apparatus of the invention for the synthesis of a biopolymer.

In one embodiment the biopolymer may be selected from the group comprising DNA, RNA, peptides, polypeptides, polysaccharides, polyhydroxyalkanoates, polyphenols, polysulfates or any combination thereof.

### DEFINITIONS

In the context of this specification, the term “comprising” means “including principally, but not necessarily solely”. Furthermore, variations of the word “comprising”, such as “comprise” and “comprises”, have correspondingly varied meanings.

The terms “well” and “microwell” are used interchangeably herein to refer to micro-scale chambers capable of accommodating a monolith or a plurality of particles. A microwell may be any shape or depth and may, in some embodiments have irregular or slanted sides. In a preferred embodiment a microwells has a depth of between about 100 μm and about 1500 μm or between about 10 μm and about 500 μm, respectively.

The terms “microchannel” and “channel” are used interchangeably herein to refer to channel of a μm scale diameter capable of accommodating a monolith and/or particles of porous substrate for biopolymer synthesis. A microchannel may be of any cross sectional shape. Fluids in the microchannels may exhibit microfluidic behavior.

### BRIEF DESCRIPTION OF THE FIGURES

FIG. 1 is a series of schematic diagrams of flow-through porous chips. Side views (left) and top views (right) of (A) silicon microwells packed with porous glass beads, (B) silicon microwells packed with sol-gel derived silica particles, (C) silicon microwells packed with monolithic sol-gel derived silica, (D) microchannel plate packed with monolithic sol-gel derived silica, (E) porous silicon channels packed with monolithic sol-gel derived silica.

FIG. 2 is a schematic diagram of microwells with (A) vertical sidewalls, (B) column sieves, and (C) an inverse bottle shape.

FIG. 3 is a series of photomicrographs of the fabricated porous substrates of the invention. (A) Silicon chip with through wells. The square wells have a width of 250 μm, and a pitch of 400 μm, (B) Silicon chip with microwells packed with porous glass beads. (C, D) Silicon chip with microwells packed with sol-gel derived silica particles of 15 μm in diameter. (E) Silicon chip with microwells packed with monolithic sol-gel derived silica. (F) Microchannel plate with a channel diameter of 5 μm and a pitch of 6 μm. (G) Microchannel plate packed with monolithic sol-gel derived silica. (H) Porous silicon channel.

FIG. 4 is a schematic of chip silanization, and selective elution of the synthesized oligonucleotides. The chemical phosphorylation linker is selectively cleaved during the oligonucleotide elution step.

FIG. 5 is a schematic of the massively parallel oligonucleotide synthesizer.

FIG. 6 is an image of a DNA microarray with wells packed with sol-gel derived silica particles of 15 μm in diameter. (A) The entire chip was synthesized with 20 base-long ATCG. (B) Fluorescence image of the chip after hybridization with 20 base-long complementary oligonucleotides end-label with Cy3 fluorescent tag.

### DETAILED DESCRIPTION

In accordance with the present invention there is provided porous substrates for biopolymer synthesis which are present in microwells and/or microchannels formed in a support structure. The porous substrates generally comprise porous glass beads or sol-gel derived silca particles or monoliths. The support structures are generally silicon or glass.

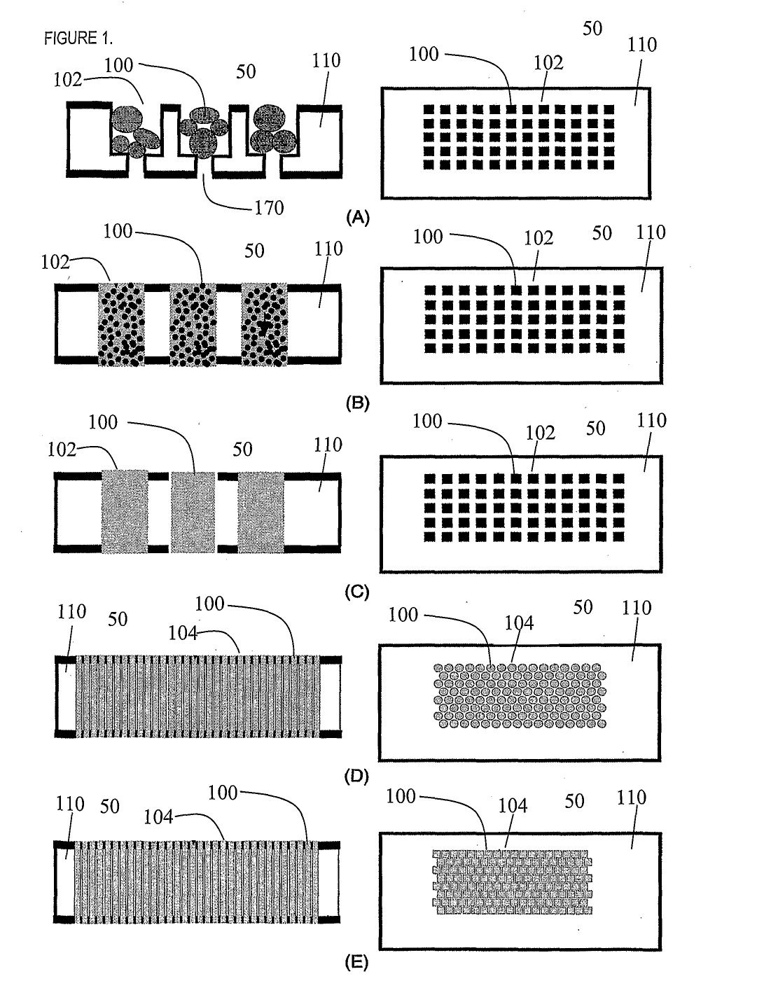

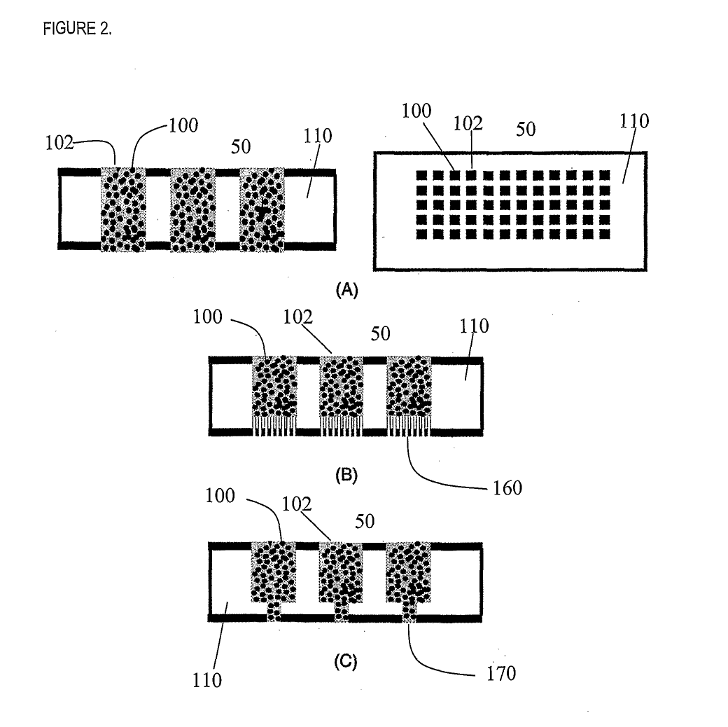

With reference to the drawings, the present invention provides an apparatus 50 for biopolymer synthesis which comprises at least one support 110 having a plurality of microwells 102 and wherein the microwells comprise a porous substrate 100 such as porous glass beads (FIG. 1(A)), sol-gel derived silica particles (FIG. 1(B)) and FIG. 2(A-C)) or monolithic sol-gel derived silica (FIG. 1(C-E)) providing a surface area for biopolymer synthesis.

In one embodiment the invention provides an apparatus 50 for biopolymer synthesis wherein the apparatus comprises at least one support 110 having a plurality of microwells 102 and wherein the microwells contain a porous substrate 100, such as sol-gel derived silica particles (FIG. 1(B)) and FIG. 2(A-C)) providing a surface area for biopolymer synthesis and wherein said microwells 102 include a sieve member 160 to retain said porous substrate 100.

In an alternative embodiment the invention provides an apparatus 50 for biopolymer synthesis wherein the apparatus comprises at least one support 110 having a plurality of microwells 102 and wherein the microwells contain a porous substrate 100, such as sol-gel derived silica particles (FIG. 1(B)) and FIG. 2(A-C)) providing a surface area for biopolymer synthesis and wherein the microwells include at least one region adapted to retain said porous substrate, for example an inverted bottle shape 170 (FIG. 1(A)) and FIG. 2(C)).

In another alternative embodiment the invention provides an apparatus 50 for biopolymer synthesis wherein said apparatus comprises at least one support 110 such as a microchannel plate or porous silicon chip, the support having a plurality of microchannels 104 and wherein the microchannels comprise a porous substrate 100 such as monolithic sol-gel derived silica providing a surface area for biopolymer synthesis.

FIG. 1 is series of schematic diagrams of flow through porous chips. The side views (left) and top view (right) are shown. In FIG. 1(A) the porous substrate 100, in this case a plurality of porous glass beads, is located in a support 110 of silicon microwells 102. In another embodiment (FIG. 1(B)) the substrate 100 is a plurality of sol-gel derived silica particles are contained in the silicon microwells 102. In these diagrams, the size of the substrate 100 (in embodiments where the substrate is porous glass beads or sol-gel derived silica particles) varing because there is typically some distribution of particle size.

In an alternative embodiment (FIG. 1(C)) the substrate 100 is monolithic sol-gel derived silica contained in silicon microwells 102. In other embodiments (FIGS. 1(D) and (E)) the support 110 is a microchannel plate or a porous silicon chip. The supports 110, each comprising microchannels 104 containing the substrate 100 of monolithic sol-gel derived silica for biopolymer synthesis.

FIG. 2 is a schematic diagram of a support 110 comprising microwells 102 with vertical sidewalls containing a substrate 100 of sol-gel derived silica particles (FIG. 2(A)). In one embodiment (FIG. 2(B)) the microwells 102 have vertical sidewalls and contain a substrate 100 of sol-gel derived silica particles. The particles are retained by a sieve member 160, column sieves are illustrated. In an alternative embodiment the microwells are of an inverse bottle shape 170 (FIG. 2(C)).

### Microwell and Microchannel Supports for Substrates

In one embodiment the present invention provides a solid support including a plurality of microwells and/or microchannels for receiving a porous substrate for biopolymer synthesis.

Typically the support is silicon, glass or any other material capable of being fabricated with microwells, microchannels or a combination thereof.

The support may be for example, a semiconductor wafer, silicon wafer, a glass or quartz microscope slide, a metal surface, a polymeric surface, a monolayer coating on a surface wherein the microwells, microchannels or a combination thereof are formed in the monolayer coating. Preferably, the solid support is a flat, thin and solid, such as silicon wafer or glass slide.

The microwells and/or microchannels are separated on the support. Preferably, the microwells and/or microchannels are fixed in a regularly spaced, two-dimensional array on the support, for example, located at the vertices of an imaginary square grid on the surface of the support. However, the invention provides for any arrangement of microwells and/or microchannels in the solid support. The invention also provides that the solid support may also act as a substrate for biopolymer synthesis.

The microwells and/or microchannels in the support provide a physical barrier that isolates at least one substrate from at least one other substrate. The physical barrier provides an advantage in that reagents for biopolymer synthesis cannot diffuse away from the substrate in the well which is a problem of existing technology. This also provides the possibility of synthesis of different polymers in different wells and/or the use of different substrates in different wells.

The microwells and/or microchannels may be of any shape but are preferably square, rectangular or circular in cross section. The sides of the wells may be substantially perpendicular to the plane of the support or may be pitched to be wider at one end than the other.

The density of the microwells and/or microchannels may be at least about 500/cm² or at least about 1000/cm² or at least about 5000/cm² or at least about 10,000/cm² or at least about 5×10⁴/cm² or at least about 1×10⁵/cm² or at least about 1×10⁶/cm² or at least about 5×10⁶/cm².

It is contemplated that the different biopolymers may be synthesised in each well. For example, in one embodiment the design of the apparatus of the invention may provide 10³ to 10⁴ unique biopolymers per substrate. In addition the high surface area of the porous substrates used in the apparatus of the invention may be at least 20 picomoles per microwell or microchannel.

The microwells may be formed in the support by any method. In particular, deep reactive ion etching (DRIE) may be used to form the microwells and microchannels.

### Deep Reactive Ion Etching (DRIE)

DRIE is a highly anisotropic, that is directional, etching process useful for creating deep, steep-sided wells and channels in supports such as silicon wafers. In the DRIE process, a support, for example a silicon wafer, in which the microwells and microchannels are to be etched is provided. A photoresist known in the art is deposited onto a top surface of the support. A negative or a positive photoresist may be used. In some embodiments the photoresist may be spun onto the support to ensure an even thickness. In one embodiment a 12 μm thick AZ4620 photoresist (Clariant Corp.) is spun on a silicon wafer (500 μm thick, 10 cm diameter). The support may subsequently be baked, for example on a hotplate to evaporate the solvent in the photoresist. The baking temperature is between about 85° C. to about 200° C. In a preferred embodiment the baking temperature is about 110° C.

The photoresist masks are patterned to correspond to the desired pattern and cross sectional shape of the microwells and/or microchannels. Photoresist masks may be patterned by any method known in the art. Typically, the desired pattern is exposed on the support using a mask aligner (for example the EVG620 mask aligner). The exposed photoresist on the support is then developed according to methods known in the art and post-baked. In a preferred embodiment the post-baking is at 120° C. for 5 min.

The DRIE process is preferably a high-anisotropy process. In a preferred embodiment the high-anisotropy DRIE process is machine controlled for example by an Alcatel AMS 100SE machine or the like. The high-anisotropy DRIE process typically uses an etching cycle with SF₆ and O₂ and a passivation cycle using C₄F₈. In one embodiment the flow rate of SF₆, O₂ and C₄F₈ is maintained at 130 sccm s⁻¹, 13 sccm s⁻¹ and 100 sccm s⁻¹, respectively. The etching and passivation time was 8 s and 5 s, respectively and the coil power of the RF plasma was 800 W. It will be understood that DRIE process is known in the art and that variations to the process described here will be routinely performed by those of skill in the art.

It will be understood that a person skilled in the art will routinely vary any one or any combination of the etching and passivation agents, times and flow rates and coil power in order to produce microwells and/or microchannels in a support in accordance with the present invention.

Microwells may be generated in the support by choosing a maximum diameter or dimension of the pattern in the photoresist used to define the etched area. Dependent on the thickness of the support to be etched, the etching process may be terminated at a point above the bottom of the support. Thus by routine selection of process parameters, microwells and/or microchannels may be generated that are wider at one end than the other.

### Substrates for Biopolymer Synthesis

The substrates for biopolymer synthesis used in the invention may be porous glass beads, silica particles, monolithic silica or any combination thereof.

The porous substrates used in the apparatus of the invention provide a reduced fluidic volume. This has the advantage of reducing the volume of reagents used in biopolymer synthesis.

### Porous Glass Beads

The porous glass beads used in the invention are commercially available. For instance, porous glass beads may be those supplied by Glen Research under the trade name Universal Support II. These beads are particles of porous silicon oxide (glass) with an average pore diameter of 500 Å or 1000 Å. Preferably the average diameter of the porous glass beads will be about 25 μm to about 750 μm or about 50 μm to about 500 μm or about 75 μm to about 425 μm or about 100 μm to about 250 μm or about 125 μm to about 175 μm.

In some embodiments the porous glass beads used in the invention may be commercially available as functionalised beads pre-prepared for biopolymer synthesis. For example the Glen Research Universal Support II beads are provided derivatised with 1-Dimethoxytrityloxy-2-O-dichloroacetyl-propyl-3-N-ureayl-polystyrene.

In some embodiments the porous glass beads of the invention may be functionalised using standard methodologies such as silanisation. In one embodiment the porous glass beads may be functionalised by incubating them with 2% N-(3-triethoxysilylpropyl)-4-(hydroxybutyramide) in ethanol for 4 h at room temperature, rinsed in 95% ethanol for 10 min, and cured in a vacuum oven at 120° C. for 12 h. The porous glass beads may also be functionalised with bis(hydroxyethyl)amino-propyltriethoxysilane or hydroxybutyramide propyltriethoxy silane.

The beads may then be treated with a spacer to prepare the beads for biopolymer (particularly nucleic acid) synthesis. The spacer may be selected from the group comprising 9-o-dimethoxytrityl-triethylene glycol, 1-[(2-cyanoethyl)-(N,N-diisopropyl)]-phosphoramidite, 18-O-Dimethoxytritylhexaethyleneglycol, 1-[(2-cyanoethyl)-(N,N-diisopropyl)]-phosphoramidite, 3-(4,4′-Dimethoxytrityloxy)propyl-1-[(2-cyanoethyl)-(N,N-diisopropyl)]-phosphoramidite, 12-(4,4′-Dimethoxytrityloxy)dodecyl-1-[(2-cyanoethyl)-(N,N-diisopropyl)]-phosphoramidite or any combination thereof.

The functionalised beads may then be loaded into the microwells and/or microchannels of the supports. In alternative embodiments the beads may be functionalise in situ in the microwells and/or microchannels.

### Sol-Gels

In one embodiment of the invention the porous substrate may be monolithic silica or silica particles derived from a sol-gel.

The term “sol-gel” refers to a wide range of procedures for producing gels that can be dried to glassy particles or monoliths. The sol-gel process utilises solutions of precursors of the intended material (for example silica) and may, for example, include the following steps:
(i) preparation of a solution, or suspension, of Si
(ii) hydrolysis, acid or base catalyzed, of the Si preparation, to form Si—OH groups, according to the reaction SiXₙ+nH₂O→Si(OH)ₙ+nHX. The mixture obtained in this way is a solution or a colloidal suspension known as “sol”
(iii) polycondensation of the Si—OH groups according to the reaction Si—OH+Si—OH→Si—O—Si+H₂O. This step is characterised by a viscosity increase and concomitant formation of a matrix known as a “gel”

Drying of the gel results in the formation of a porous monolithic body, particularly when the gel is formed and dried in microchannels or microwells. Drying can be carried out by a controlled solvent evaporation, which produces a xerogel, or by a solvent supercritical extraction which produces an aerogel. The dried gel can be used in the microwell and/or microchannel supports of the invention in this form or it may be densified by a thermal treatment to prepare a glassy monolith or particles.

The colloidal (sol) solution in step ii) above may be prepared by mixing one or more metallic or metalloid oxide precursors (represented above by Si) with water or water/alcohol in the presence of a catalyst such as an acid or a base. The metallic or metalloid oxide may be a cation, n valenced, of an element belonging to groups 3, 4 or 5 of the Periodic Table but particularly may be Si, Ge, Ti, Al or any combination thereof. X as used above may be selected from the group comprising oxide, alkoxide, methoxy, tetramethoxy, ethoxy, propoxy or butoxy or any combination thereof.

The hydrolysis step (step (iii) above) may be carried out at room temperature from about 5 minutes to more than 4 hours or until hydrated oxides of the cation(s) form the sol. Before gelling, the sol may be supplemented by a colloidal suspension of the oxide of at least one of the present cations. For example, if use is made of a precursor comprising silicon oxide a solution/suspension prepared by mixing water, optionally a further solvent, fumed silica, an acid or a base may be added to the sol.

The sol gelling may be carried out by incubating the sol at a temperature typically lower than about 90° C. over a time period of at least a few minutes.

After gelling the gel is washed, for example by water and methanol or another organic solvent such that the solvent in the gel is replaced by a non-protic solvent or by water and methanol. A non-protic solvent may be selected from the group comprising acetone, dioxane, hydrofuran.

The gel so obtained may then be dried in a pressure chamber purged with an inert gas and at a pressure suitable to achieve, at a temperature lower than the gel solvent critical temperature, a total pressure lower than the solvent critical pressure. Under such conditions the pressure chamber temperature is increased according to a predetermined program such that the gel solvent evaporates to produce a dried sol-gel.

The dried sol-gel may be subjected to vitrification wherein the dry sol-gel is heated to above about 100° C. to about 1650° C. under normal atmosphere or an inert gas atmosphere. The gas may be selected from the group consisting of nitrogen, argon, helium, oxygen, chlorine, and the like. The dried sol-gel may be heated for a period of time from about ten of minute to many hours.

In some embodiments of the present invention the sol-gel may be formed in the microchannels of the supports to form a monolithic sol-gel silica chip. A support with microwells and/or microchannels is first cleaned and prepared for the sol-gel process for example by treating the support with 1M aqueous sodium hydroxide solution at 40° C. for 3 h, washed with water and acetone, and then dried.

### Silica Particles and Monoliths

In one embodiment a monolithic silica chip is formed for example by addition of tetramethoxysilane (TMOS, 40-70 ml) to a solution of poly(ethylene glycol) (PEG, 8-13 g) and urea (9.0 g) in 0.01M acetic acid (100 ml) which is stirred at about 4° C. to about 40° C. for about 30 min. In an alternative embodiment a monolithic silica chip is formed for example by addition of PEG (0.9-1.1 g), TMOS+MTMS (tetramethoxysilane+methyltrimethoxysilane) (9 ml in 1:1 volume ratio), urea 2.0 g in 0.01M acetic acid (20 ml) stirred at about 4° C. to about 40° C. for about 30 min. The solution is then charged into the chip and allowed to react (gel) at 25° C. overnight. The monolithic silica chip is then dried at 120° C. for 3 h, and washed with water and methanol. After drying, the silica chip was vitrified by heating at a rate of 10° C. min⁻¹ and held at 350° C. for 12 h. Sol-gel silica particles used in the present invention may be prepared in the same manner as the monolithic silica chip but with the additional step of adding silica particles to the TMOS precursor. Preferably the silica particles have a diameter of about 5 to about 35 μm, or preferably about 15 μm.

### Surface Area of Substrates for Biopolymer Synthesis

In one embodiment of the surface area of the substrates is from about 10 m²/g to about 200 m²/g or from 20 m²/g to about 180 m²/g or from 30 m²/g to about 160 m²/g or from 30 m²/g to about 140 m²/g or from 40 m²/g to about 120 m²/g or from 50 m²/g to about 110 m²/g or from 60 m²/g to about 100 m²/g.

### Yield of Biopolymer

The high surface area of the porous substrates used in the apparatus of the invention may be sufficient for a yield of biopolymer in each microwell or microchannel of at least about 1 attomole or at least about 1 picomole, or at least about 5 picomoles or at least about 10 picomoles, or at least about 20 picomoles, or at least about 50 picomoles, or at least about 100 picomoles, or at least about 500 picomoles, or at least about 1 nanomole, or at least about 5 nanomoles.

### Biopolymer Synthesis

The substrates of the invention may be used to synthesise biopolymer selected from the group comprising DNA, RNA, peptides, polypeptides, polysaccharides, polyhydroxyalkanoates, polyphenols, polysulfates.

### Oligonucleotide Synthesis

In one embodiment of the invention the biopolymer synthesised is a nucleic acid, particularly an oligonucleotide of DNA and/or RNA.

Oligonucleotides are typically synthesised using phosphoramidite synthesis. The phosphoramidite synthesis chemistry consists of four stages, namely detritylation, coupling, capping and oxidation. DNA and RNA can be chemically synthesized typically by a chemical procedure known as the “phosphoramidite methodology” which is widely known and commercially available. Critical to nucleic acid synthesis is the specific and sequential formation of phosphate linkages between the 5′-OH and 3′-P groups of separate nucleotides. The 5′-OH and 3′-P groups must be modified to react appropriately in the synthesis of the oligonucleotide. Typically 5′-OH groups are modified (typically with a dimethoxytrityl (“DMT”) group) to prevent premature bonding with another moiety. Accordingly, the first step in nucleic acid synthesis is detritylation of the nucleotide to allow it to bond with a 3′-P of another nucleotide provided so two nucleotides are properly combined. Detritylation is commonly performed using about 2-5% trichloroacetic acid in dichloromethane for about 20 seconds to about 90 seconds.

The second step of oligonucleotide synthesis is coupling of one nucleotide with another. Typically in the coupling reaction an activated intermediate is created by simultaneously adding the phosphoramidite nucleotide monomer and tetrazole to the reaction. The tetrazole protonates the nitrogen of the phosphoramidite thereby making it susceptible to nucleophilic attack and allowing the formation of a phosphite triester bond between 3′-P of the phosphoramidite monomer and the 5′-OH of detritylated nucleotides. The 5′-OH of the extended phosphoramidite nucleotide is blocked with a DMT group. Coupling reactions are typically performed over a period of about 10 seconds to about 90 seconds.

The next step of oligonucleotide synthesis is capping of any unreacted 5′-OH groups to terminate any oligonucleotides that did not have a base added. Capping is typically performed by acetylation using acetic anhydride and 1-methylimidazole for a period of about 5 seconds to about 90 seconds. Since the extended phosphoramidite nucleotides in the previous step are still blocked with a DMT group they are not affected. Capping minimizes the length of contaminating (that is incorrectly formed) oligonucleotides thereby facilitating identification and purification of the desired oligonucleotide.

The final step of oligonucleotide synthesis is oxidation of the unstable phosphite triester bond between the 5′-OH and 3′-P groups to a more stable phosphate triester bond. Typically this is achieved using iodine and water in tetrahydrofuran where iodine is used as the oxidant and water is used as the oxygen donor.

By repeating these four steps an oligonucleotide having a defined sequence can be accurately generated.

During synthesis, nucleotides must be “temporarily” protected, i.e. reactive sites on the nucleotide must be blocked from reacting inappropriately until after oligonucleotide synthesis is complete. The protecting groups must also be capable of being removed so that the biological activity of the oligonucleotide is not affected. Protecting the base prevents exocyclic amino groups competing for binding to the 5′-OH group during synthesis. The most widely used protecting groups used in conjunction with the phosphoramidite methodologies for oligonucleotide synthesis are benzoyl and isobutyryl.

Once synthesis of the oligonucleotide is complete these protecting groups can be removed (the oligonucleotide is deprotected) with an ammonia compound. Typically this involves incubating the oligonucleotide with an ammonia compound, such as a solution of 25%-35% of ammonium hydroxide or a mixture of 30% ammonium hydroxide/40% methylamine in 1:1 volume ratio for a period of about 3 hours to about 24 hours at a temperature of about 50° C. to about 80° C. A typical deprotection protocol involves incubation of the oligonucleotide in a solution of 30% ammonium hydroxide for 16 hours at 55° C. In other embodiments deprotection may be performed by incubating the oligonucleotides in 1:1 (by vol) ethylenediamine/ethanol solutions for about 6 hours.

### Selective Elution

Oligonucleotides synthesised on the porous substrates of the apparatus of the invention may be selectively eluted from the substrate by incorporating a cleavable linker between the substrate and the oligonucleotide. The cleavable linker may be susceptible to chemical or enzymatic cleavage. In a preferred embodiment the cleavable linker may be susceptible to cleavage by ammonium hydroxide, for example [3-(4,4′-Dimethoxytrityloxy)-2,2-dicarboxyethyl]propyl-(2-cyanoethyl)-(N,N-diisopropyl)-phosphoramidite (Chemical Phosphorylation Reagent II, Glen Research).

In order to synthesise oligonucleotides for selective elution from the substrate, typically a porous glass substrate, is functionalised. The functionalising agent may be N-(3-triethoxysilylpropyl)-4-(hydroxybutyramide) which may be used at a concentration of 2% in ethanol for 4 h at room temperature. Other functionalising agents for use in the invention include bis(hydroxyethyl)amino-propyltriethoxysilane and hydroxybutyramide propyltriethoxy silane. Combinations of functionalising agents are also contemplated. After treatment with the functionalising agent the substrate is washed to remove excess functionalising agent typically with 95% ethanol for about ten minutes. Following this washing step the functionalised substrate is cured in a vacuum oven. For example at about 105° C. to about 150° C. for about 4 h to about 24 h.

The functionalised substrate is then treated with a spacer. The spacer may be selected from the group comprising 9-o-dimethoxytrityl-triethylene glycol, 1-[(2-cyanoethyl)-(N,N-diisopropyl)]-phosphoramidite (Spacer Phosphoramidite 9, Glen Research), 18-O-Dimethoxytritylhexaethyleneglycol, 1-[(2-cyanoethyl)-(N,N-diisopropyl)]-phosphoramidite, 3-(4,4′-Dimethoxytrityloxy)propyl-1-[(2-cyanoethyl)-(N,N-diisopropyl)]-phosphoramidite. 12-(4,4′-Dimethoxytrityloxy)dodecyl-1-[(2-cyanoethyl)-(N,N-diisopropyl)]-phosphoramidite or any combination thereof.

A cleavable linker such as [3-(4,4′-Dimethoxytrityloxy)-2,2-dicarboxyethyl]propyl-(2-cyanoethyl)-(N,N-diisopropyl)-phosphoramidite (Chemical Phosphorylation Reagent II, Glen Research) is then added following the manufactures protocol to prepare the substrate for oligonucleotide synthesis. The cleavable linker may be selected from the group comprising [3-(4,4′-Dimethoxytrityloxy)-2,2-dicarboxyethyl]propyl-(2-cyanoethyl)-(N,N-diisopropyl)-phosphoramidite; 2-[2-(4,4′-Dimethoxytrityloxy)ethylsulfonyl]ethyl-(2-cyanoethyl)-(N,N-diisopropyl)-phosphoramidite; [3-(4,4′-Dimethoxytrityloxy)-2,2-dicarboxymethylamido]propyl-(2-cyanoethyl)-(N,N-diisopropyl)-phosphoramidite (e.g. Solid CRP II, Glen Research) or any combination thereof.

Following oligonucleotide synthesis oligonucleotides can be selectively cleaved from the substrate using ammonium hydroxide by applying an ammonium hydroxide solution to at least a portion of the substrate and incubated for 5 min. Then, the cleaved oligonucleotides are flushed with 30% ammonium hydroxide and collected. After cleavage and flushing, the oligonucleotides may be further deprotected in ammonium hydroxide. For example in 30% ammonium hydroxide for 16 h at 55° C. In other embodiments deprotection may be performed by incubating the oligonucleotides in 1:1 (by vol) ethylenediamine/ethanol solutions for about 6 hours.

The present invention will now be further described in greater detail by reference to the following specific examples, which should not be construed as in any way limiting the scope of the invention.

### EXAMPLES

### Example 1

### Preparation of Microwells and/or Microchannels in a Silicon Wafer

A silicon wafer (500 μm thick, 10 cm diameter) was used as a support. A 12 μm thick AZ4620 photoresist (Clariant Corp.) was spun on the wafer. The wafer was baked at 110° C. on a hot plate. The desired pattern was then exposed on the wafer using a mask aligner (EVG620), developed and post-baked at 120° C. for 5 min. The Alcatel AMS 100SE machine was used in the high-anisotropy DRIE process. This AMS 100SE system utilizes an etching cycle with SF₆ and O₂ and then switches to a passivation cycle using C₄F₈. The flow rate of SF₆, O₂ and C₄F₈ was kept at 130 sccm s⁻¹, 13 sccm s⁻¹ and 100 sccm s⁻¹, respectively, the etching and passivation time was 8 s and 5 s, respectively and the coil power of the RF plasma was 800 W.

### Example 2

### Preparation of Monolithic Sol-Gel Silica Chip

A monolithic sol-gel silica chip is prepared as follows. The chip, previously etched to contain microcells and/or microchannels was treated with 1 M aqueous sodium hydroxide solution at 40° C. for 3 h, washed with water and acetone, and then dried. Tetramethoxysilane (TMOS, 40 ml) was added to a solution of poly(ethylene glycol) (PEG, 12.4 g) and urea (9.0 g) in 0.01 M acetic acid (100 ml) and stirred at 4° C. for 30 min. The solution was charged into the chip and allowed to react at 25° C. overnight. Then, the monolithic silica chip was treated at 120° C. for 3 h, and washed by water and methanol. After drying, the silica chip was heated at a rate of 10° C. min⁻¹ and held at 350° C. for 12 h.

Sol-gel silica particles are formed in the chip in the same manner as above but for the addition of silica particles with diameter of 15 μm to the TMOS precursor.

### Example 3

### Microfabricated Silicon Microwells

The first design, illustrated in FIG. 1A, utilises microfabricated silicon microwells, and then physically trapped the porous glass beads (Universal Support II, Glen Research). The diameters of the porous glass beads were in the range of 125 μm to 175 μm. The inverse bottle-shaped microwells were designed with a bottleneck width of 100 μm, smaller than the size of the beads to effectively trap the porous glass beads. By adjusting the well pitch between 200 μm and 400 μm, the density of microwells could be controlled between 2500 spots/cm² and 625 spots/cm².

The second and third designs (FIGS. 1B and 1C) have the silicon wells filled with sol-gel derived silica particles and monolithic sol-gel derived silica, respectively. The sol-gel precursors were loaded into microwells, and cured to form silica gel. The microwell density was limited by the microfabrication process. Microwells with a width of 30 μm and a pitch of 60 μm could be created using reactive ion etching on 350 μm thick silicon substrate to give a microwell density of 2.7×10⁴ spots/cm². Three different microwell designs were employed to effectively immobilize the fabricated porous columns in microwells during oligonucleotide synthesis whereby a fluidic pressure was applied to the porous columns. For microwells with a width of <100 μm, a vertical sidewall design was employed (FIG. 2A). For wider wells, a design of column sieves (FIG. 2B) or inverse bottle shape (FIG. 2C) was utilized, which strained the porous columns even if they were delaminated from the sidewalls.

The fourth design uses a microchannel plate to replace the silicon microwells. The commercially available microchannel plate was made of silica with various channel diameters and pitch dimensions. It can provide much higher array density than silicon microwells. The microchannel plate employed in this experiment has a channel diameter of 5 μm and a pitch of 6 μm, which corresponded to an array density of 2.7×10⁶ spots/cm². The surface area was further increased by packing the microchannels with monolithic sol-gel derived silica (FIG. 1D). Another approach was to create the microchannels on silicon using macroporous silicon etching method, and then pack the microchannels with monolithic sol-gel derived silica (FIG. 1E). This method could provide array densities as high as the microchannel plate.

### Example 4

### Flow-Through Porous Substrates

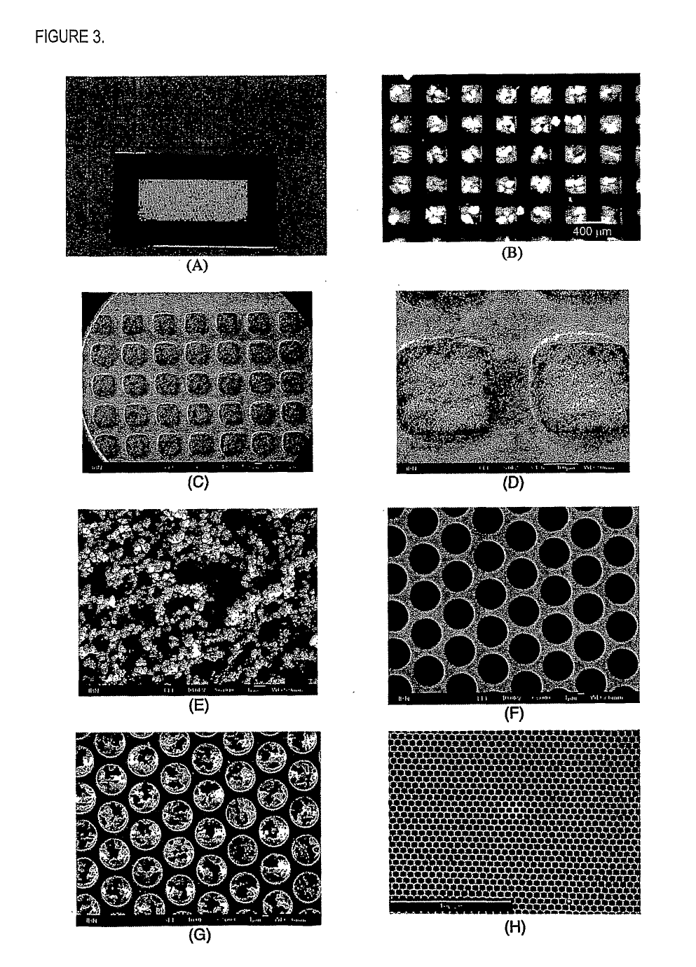

FIG. 3 shows the fabricated flow-through porous substrates. Silicon chips containing microwells were created using deep reactive ion etching (DRIE) on a 500 μm thick silicon substrate (FIG. 3A). The chip packed with porous glass beads (Universal Support II, Glen Research) is shown in FIG. 3B, which has square wells with a width of 250 μm and a pitch of 400 μm, resulting in an array density of 625 spots/cm². The porous glass beads with universal linkers were standard substrates for oligonucleotide synthesis. They have irregular shapes and resulted in varying surface areas for the wells. Uniformity in surface area was dramatically improved by packing the wells with sol-gel derived silica particles (15 μm-diameter, Chemikalie Pte Ltd, Singapore) (FIGS. 3C and 3D) or monolithic sol-gel derived silica using tetraethoxysilane (TEOS) or tetramethoxysilane (TMOS) sol-gel precursors (FIG. 3E). The surface area, skeleton size and pore size could be controlled by adjusting the sol-gel precursors and processing conditions.

FIG. 3F is the 300 μm thick microchannel plate with a channel diameter of 5 μm and a pitch of 6 μm (GCA 25/6/5/0/03, Photonis, Inc.). The channels were filled with monolithic sol-gel TMOS-derived silica (FIG. 3G). The densely packed microchannels provided a much higher array density than the silicon microwells chip. It also made the monomer dispensing much easier for oligonucleotide synthesis whereby nanoliter dispensers were used to dispense the 4 phosphoramidite monomers into each porous structure. The droplet diameter (50-100 μm) from the nanoliter dispenser was on the order of the microwell's dimensions. Thus, to achieve accurate reagent delivery into each microwell, we have to align the dipensers with the microwells. In contrast, a 100 μm-diameter droplet would cover more than 200 microchannels with a pitch of 6 μm, eliminating the need for substrate alignment, and any effect due to non-uniformity in the microchannels. Also, in place of the costly commercial microchannel plates, macroporous silicon channels could be fabricated with the macroporous silicon etching method (FIG. 3H), which was capable of providing similar channel dimensions as the microchannel plates.

### Example 4

### Functionalisation of Porous Chips

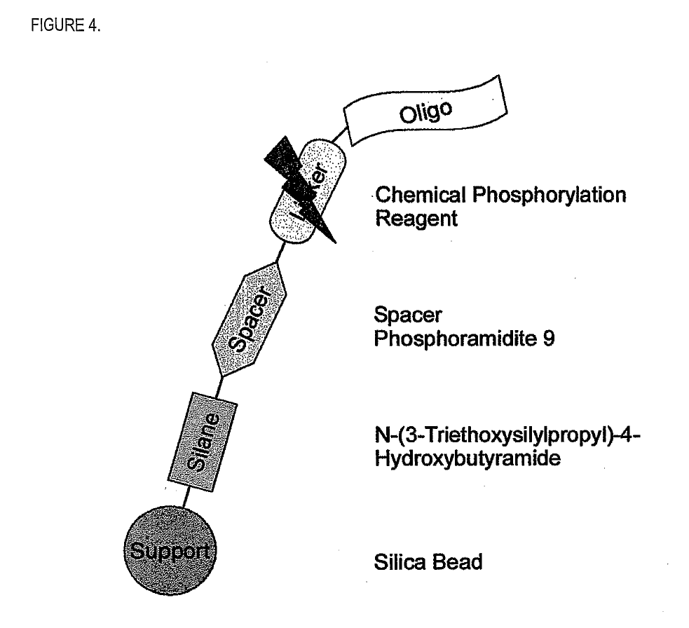

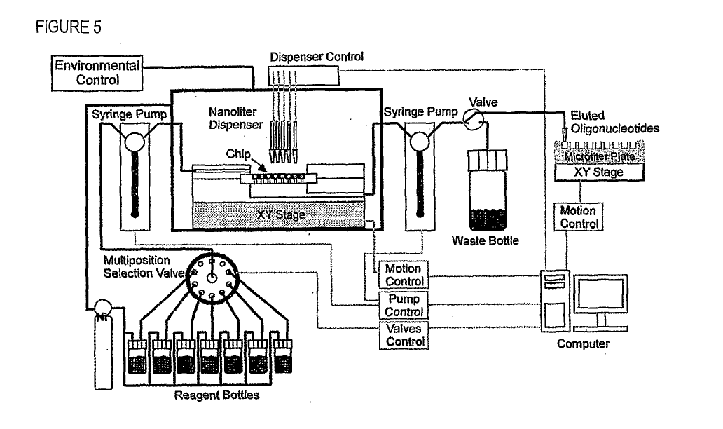

The flow-through porous chip could be used as a supporting substrate for the syntheses of oligonucleotides, peptides and small molecules. We have successfully demonstrated oligonucleotide synthesis on these porous substrates. To provide functional groups on the porous substrates for oligonucleotide synthesis (FIG. 4), the fabricated substrate was gently shaken in a solution of 2% N-(3-triethoxysilylpropyl)-4-(hydroxybutyramide) (Gelest) in ethanol for 4 h at room temperature, rinsed in 95% ethanol for 10 min, and cured in a vacuum oven at 120° C. for 12 h. The chip was then treated with 9-o-dimethoxytrityl-triethylene glycol, 1-[(2-cyanoethyl)-(N,N-diisopropyl)]-phosphoramidite (Spacer Phosphoramidite 9, Glen Research) and 3-(4,4′-dimethoxytrityloxy)-2,2-dicarboxyethyl]-propyl-(2-cyanoethyl)-(N,N-diisopropyl)-phosphoramidite (Chemical Phosphorylation Reagent, Glen Research) by following the manufacturer's protocol. The Chemical Phosphorylation Reagent was employed for the selective cleavage of the synthesized oligonucleotides. The functionalized, activated porous substrate was then loaded into the massively parallel oligonucleotide synthesizer (a schematic of which is shown in FIG. 5).

### Example 5

### Functionalisation of Porous Glass Substrates

Porous glass substrates were functionalised by incubating them with 2% N-(3-triethoxysilylpropyl)-4-(hydroxybutyramide) in ethanol for 4 h at room temperature, rinsed in 95% ethanol for 10 min, and cured in a vacuum oven at 120° C. for 12 h. The silanized substrate was treated with a spacer chemistry such as 9-o-dimethoxytrityl-triethylene glycol, 1-[(2-cyanoethyl)-(N,N-diisopropyl)]-phosphoramidite (Spacer Phosphoramidite 9, Glen Research), and then a cleavable linker such as [3-(4,4′-Dimethoxytrityloxy)-2,2-dicarboxyethyl]propyl-(2-cyanoethyl)-(N,N-diisopropyl)-phosphoramidite (CRP II, Glen Research), following the manufacture's protocol to prepare the substrate for oligonucleotide synthesis.

### Example 6

### Selective Elution of Oligonucleotides

Oligonucleotides were synthesised using phosphoramidite synthesis known in the art. Detritylation was performed with, 75 μl of 3% trichloroacetic acid in dichloromethane injected to cover the whole chip. The detritylation reaction was conducted for 50 s. For coupling, the whole chip was first flushed with 50 μl tetrazole, and then each well was dispensed with one droplet of phosphoramidite. The reaction was allowed to proceed for 45 s before the reagents were drained away. Capping reagent (45 μl) was then injected to cover the whole chip, left for 10 s and drained away. Then 50 μl of the oxidation reagent was delivered to the chip, left for 25 s and drained away. A wash step with 60 μl of acetonitrile was added between each process stages. The process was repeated for the desired oligonucleotide length.

After the oligonucleotides were synthesized using the massive parallel oligonucleotide synthesizer (FIG. 5), oligonucleotides were optionally selectively cleaved from the porous substrate using ammonium hydroxide. Droplets of ammonium hydroxide were selectively dispensed into the porous wells using a nano-liter dispenser (part of massively parallel oligonucleotide synthesizer), and incubated for 5 min. Then, the cleaved oligonucleotides were flushed with 50 μl of 30% ammonium hydroxoide and transferred to collection plate, which were further deprotected for 16 h at 55° C.

### Example 7

### Microarray Analysis

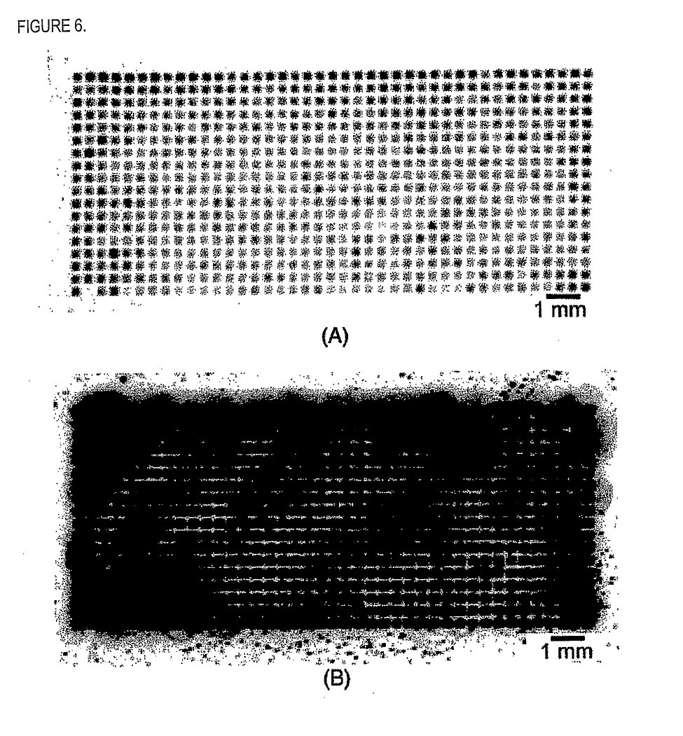

Oligonucleotide synthesis was successfully demonstrated on the massively parallel oligonucleotide synthesizer with porous chips. FIG. 6 shows the DNA microarray synthesis using a chip with microwells packed with sol-gel derived silica particles. The entire chip was synthesized with 20 base-long ATCGATCGATCGATCGATCG (FIG. 6A). Then, the protecting groups were removed in 1:1 (by vol) ethylenediamine/ethanol solutions for 6 h. The resulting chip was then hybridized with 20 base-long complementary oligonucleotides end-labeled with Cy3 fluorescent tag. The fabricated chip was hybridized to a solution of 100 nM 3′-Cy3-labeled complementary oligonucleotide in hybridization buffer (50 mM MES (2-[N-morpholino]ethanesulfonic), 0.5 M NaCl, 10 mM EDTA, 0.005% (v/v) Tween-20) for 4 hours at 40° C., and then extensively washed with 6×SSPE Buffer (0.9 M Sodium Chloride, 60 mM Sodium Hydrogen Phosphate, 6 mM EDTA, pH 7.4). After the hybridization and washing with wash buffer the hybridization fluorescent image was measured with a fluorescent imager (Typhoon 9400, GE Healthcare). The fluorescent image (FIG. 6B) of DNA hybridization indicates the successful synthesis of target oligonucleotides with porous chips.

1. An apparatus for biopolymer synthesis wherein said apparatus comprises
at least one support having a plurality of microwells and wherein
said microwells comprise a porous substrate providing a surface area for biopolymer synthesis.

2. An apparatus for biopolymer synthesis wherein said apparatus comprises
at least one support having a plurality of microwells and wherein
said microwells contain a porous substrate providing a surface area for biopolymer synthesis and wherein
said microwells include a sieve member to retain said porous substrate.

3. An apparatus for biopolymer synthesis wherein said apparatus comprises
at least one support having a plurality of microwells and wherein
said microwells contain a porous substrate providing a surface area for biopolymer synthesis and wherein
said microwells include at least one region adapted to retain said porous substrate.

4. The apparatus of any one of claims 1 to 3 wherein the support is a chip of glass or silicon.

5. The apparatus of any one of claims 1 to 3 wherein the support is a microwell plate.

6. The apparatus of any one of claims 1 to 5 wherein the porous substrate provides a high surface area for biopolymer synthesis.

7. The apparatus of claim 6 wherein the high surface area is from about 10 m²/g to about 200 m²/g or from 20 m²/g to about 180 m²/g or from 30 m²/g to about 160 m²/g or from 30 m²/g to about 140 m²/g or from 40 m²/g to about 120 m²/g or from 50 m²/g to about 110 m²/g or from 60 m²/g to about 100 m²/g.

8. The apparatus of claim 6 wherein the biopolymer is selected from the group consisting of DNA, RNA, peptides, polypeptides, polysaccharides, polyhydroxyalkanoates, polyphenols, polysulfates or any combination thereof.

9. The apparatus of claim 8 wherein the biopolymer is an oligonucleotide.

10. The apparatus of any one of claims 1 to 7 wherein the porous substrate is selected from the group consisting of porous glass beads, silica particles, monolithic silica or a combination thereof.

11. The apparatus of claim 10 wherein the monolithic silica and/or silica particles are formed in the microwells.

12. The apparatus of claim 11 wherein the monolithic silica or silica particles are sol-gel derived.

13. The apparatus of any one of claims 1 to 12 wherein the porous substrate is functionalised with at least one of N-(3-triethoxysilylpropyl)-4-(hydroxybutyramide), bis(hydroxyethyl)amino-propyltriethoxysilane, hydroxybutyramide propyltriethoxy silane or any combination thereof.

14. The apparatus of claim 13 wherein the porous substrate is treated with 9-o-dimethoxytrityl-triethylene glycol, 1-[(2-cyanoethyl)-(N,N-diisopropyl)]-phosphoramidite.

15. The apparatus of claim 14 wherein the porous substrate may be functionalised with a cleavable linker to allow selective elution of the synthesised biopolymer.

16. The apparatus of claim 15 wherein the cleavable linker is selected from the group consisting of [3-(4,4′-Dimethoxytrityloxy)-2,2-dicarboxyethyl]propyl-(2-cyanoethyl)-(N,N-diisopropyl)-phosphoramidite; 2-[2-(4,4′-Dimethoxytrityloxy)ethylsulfonyl]ethyl-(2-cyanoethyl)-(N,N-diisopropyl)-phosphoramidite; [3-(4,4′-Dimethoxytrityloxy)-2,2-dicarboxymethylamido]propyl-(2-cyanoethyl)-(N,N-diisopropyl)-phosphoramidite or any combination thereof.

17. An apparatus for biopolymer synthesis wherein said apparatus comprises
at least one support having a plurality of microchannels and wherein
said microchannels comprise a porous substrate providing a surface area for biopolymer synthesis.

18. The apparatus of claim 17 wherein the support is a chip of glass or silicon.

19. The apparatus of claim 17 or claim 18 wherein the support is a microchannel plate.

20. The apparatus of any one of claims 17 to 19 wherein the porous substrate provides a high surface area for biopolymer synthesis.

21. The apparatus of claim 20 wherein the high surface area is from about 10 m²/g to about 200 m²/g or from 20 m²/g to about 180 m²/g or from 30 m²/g to about 160 m²/g or from 30 m²/g to about 140 m²/g or from 40 m²/g to about 120 m²/g or from 50 m²/g to about 110 m²/g or from 60 m²/g to about 100 m²/g.

22. The apparatus any one of claims 17 to 21 wherein the porous substrate is selected from the group consisting of porous glass beads, silica particles, monolithic silica or a combination thereof.

23. The apparatus of claim 22 wherein the monolithic silica or silica particles are formed in the microchannels.

24. The apparatus of claim 22 or claim 23 wherein the monolithic silica or silica particles are sol-gel derived.

25. The apparatus of any one of claims 17 to 24 wherein the porous substrate is functionalised with N-(3-triethoxysilylpropyl)-4-(hydroxybutyramide), bis(hydroxyethyl)amino-propyltriethoxysilane, hydroxybutyramide propyltriethoxy silane or any combination thereof.

26. The apparatus of claim 25 wherein the porous substrate is treated with 9-o-dimethoxytrityl-triethylene glycol, 1-[(2-cyanoethyl)-(N,N-diisopropyl)]-phosphoramidite.

27. The apparatus of claim 25 wherein the porous substrate may be functionalised with a cleavable linker to allow selective elution of the synthesised biopolymer.

28. The apparatus of claim 27 wherein the cleavable linker is selected from the group consisting of [3-(4,4′-Dimethoxytrityloxy)-2,2-dicarboxyethyl]propyl-(2-cyanoethyl)-(N,N-diisopropyl)-phosphoramidite; 2-[2-(4,4′-Dimethoxytrityloxy)ethylsulfonyl]ethyl-(2-cyanoethyl)-(N,N-diisopropyl)-phosphoramidite; [3-(4,4′-Dimethoxytrityloxy)-2,2-dicarboxymethylamido]propyl-(2-cyanoethyl)-(N,N-diisopropyl)-phosphoramidite or any combination thereof.

29. Use of the apparatus of any one of claims 1 to 28 for the synthesis of a biopolymer.

30. The use of claim 29 wherein the biopolymer is selected from the group consisting of DNA, RNA, peptides, polypeptides, polysaccharides, polyhydroxyalkanoates, polyphenols, polysulfates or any combination thereof.


SEQUENCE LISTING (1 sequence)

SEQ ID NO: 1 - DNA, 20 bp, Artificial Sequence
  Synthetic
atcgatcgatcgatcgatcg